(19) United States
(12) Patent Application Publication
(10) Pub. No.: US 2004/0065165 A1
(43) Pub. Date: Apr. 8, 2004

(54) Accelerator operating device

(76) Inventors: Mitsuru Sekiya, Odawara-shi (JP); Kazuaki Zama, Odawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/469,157

(22) PCT Filed: Feb. 12, 2002
(86) PCT No.: PCT/JP02/01126

(30) Foreign Application Priority Data
Feb. 28, 2001 (JP) 2001-053638

(51) Int. Cl. G05G 1/00

(52) U.S. Cl. 74/491

(57) ABSTRACT

This apparatus comprises a thumb lever 10 which is supported rotatably around an axis of a shaft portion 11, a return spring 13 to urge the thumb lever 10 towards an initial position, and a position sensor 20 which detects a rotating angle of the thumb lever 10 around the axis of the shaft portion 11, and outputs electronic signals as information of the accelerator position while the position sensor 20 detects the rotating angle of the thumb lever 10. In this manner, a drive-by-wire system is adopted to an accelerator operating portion of motorcycles etc. without losing the steering operativity.

### TECHNICAL FIELD

The present invention relates to an accelerator apparatus which is employed to vehicles, such as motorcycles, leisure vehicles, snowmobiles, leisure boats or the like, to which a thumb lever or an accelerator grip etc. for hand-operated accelerator operation is attached to a steering handle. It especially relates to an accelerator apparatus which outputs accelerator position information as electronic signals.

### BACKGROUND ART

With vehicles such as motorcycles, leisure vehicles, snowmobiles, leisure boats or the like, in order to control an engine accelerator position, an accelerator grip or a thumb lever etc. which is attached to a steering handle is rotated by a hand or a finger. Via an accelerator cable which is connected directly to it, an opening of a carburetor or a throttle valve is controlled.

On the other hand, with automobiles or the like, in order to obtain precise and exhaustive control of a combustion state, power, revolution control and so on of the engine, which is better than the acceleration control which a driver intends, a drive-by-wire system (DBW) is developed. In this system, the accelerator pedal and the throttle valve are not connected by the accelerator cable. The depressing amount of the accelerator pedal is detected by a sensor and converted to an electronic signal. Based on the converted electronic signal, the power control and the like are performed.

Therefore, with vehicles such as motorcycles, leisure vehicles, snowmobiles, leisure boats or the like, it is also contemplated to adopt the drive-by-wire system in order to obtain more precise and exhaustive control etc.

However, while the accelerator operation of automobiles is performed by depressing the accelerator pedal which is attached to a vehicle body, the accelerator operation of motorcycles, leisure vehicles or the like is performed by rotating the accelerator grip or the thumb lever, which is attached to the steering handle, by a hand or a finger.

Here, operating force, operating circumstance, required characteristics and so on of such vehicles differ greatly from those of automobiles. Therefore, it is difficult to simply just adopt the automobile drive-by-wire system as-is.

Specifically, since the handle is operated for steering, it is desirable to be lightened as much as possible. Therefore, the drive-by-wire system which is attached to the handle has to be lightened and compacted as much as possible.

Further, since the accelerator grip or the thumb lever etc. is operated by twisting or bending a thumb or a forefinger etc., the working angle of the sensor has to be set relatively large in accordance with the operating amount.

Furthermore, the accelerator grip or the thumb lever etc. is designed to withstand the hand-operating force. In comparison with the supporting structure of the accelerator pedal, relatively simple structure is employed. Therefore, relatively large wobbles with a supporting shaft may exist. However, even at such a state with wobbles, the rotating angle has to be detected accurately.

The present invention is accomplished in the light of the abovementioned points. The purpose is to provide an accelerator apparatus which is employed to vehicles which accelerator position is controlled by hand-operation, such as motorcycles, leisure vehicles, snowmobiles, leisure boats or the like, with a drive-by-wire system which can perform precise and exhaustive control while achieving downsizing, weight saving, structure simplification and so on without losing the operativity of the steering handle.

### DISCLOSURE OF THE INVENTION

The accelerator apparatus of the present invention is an accelerator apparatus which is attached to a steering handle of a vehicle and which outputs electronic signals of the accelerator position while the position is controlled by hand-operation. It comprises a hand-operating portion which is supported rotatably around an axis of a specific shaft, urging means which urges the hand-operating portion to return to a specific position, and detecting means which detects a rotating angle of the hand-operating portion around the axis of the specific shaft.

With this structure, the drive-by wire system is provided, wherein the system detects the rotating angle of the hand-operating portion and outputs electronic signals as the accelerator information when the hand-operating portion is rotated from a specific position rested by the urging means.

Here, since the detecting means is formed to detect the rotating angle around the axis at which the hand-operating portion rotates, the hand-operating portion and the detecting means can be located closely, and the apparatus can be downsized.

With the abovementioned structure, the axis of the specific shaft can be located at a twisted or intersecting position to the axis of the handle, and the hand-operating portion can be a lever which one end is formed to rotate integrally with the specific shaft and the other end is a free-end.

With this structure, the drive-by-wire system is provided with the lever (a thumb lever, for example) which is operated by a thumb, a forefinger or the like.

Further, with the abovementioned structure, the axis of the specific shaft can be located at almost the same position as the axis of the handle, and the hand-operating portion can be an accelerator grip which is fitted outside and supported rotatably to the shaft of the handle.

With this structure, the drive-by-system is provided with the accelerator grip which is operated by hand grabbing and wrist turning.

With the abovementioned structure, the detecting means can be a non-contact type position sensor to output signals in accordance with a rotating angle of a rotor, wherein the position sensor comprises the rotor which has a magnet piece formed as a curved arc shape and formed to rotate in synchronization with the rotation of the hand-operating portion, a first stator which has a magnetic part formed to face the magnet piece-with a specific gap, a second stator which has two magnetic parts formed to face the magnet piece and the magnetic part with a specific gap, an armature which forms a magnetic path, and a magnetic sensor portion which is disposed between the first stator and the second stator and outputs electronic signals in accordance with changes of magnetic flux.

With this structure, when the rotor rotates in accordance with the operation of the hand-operating portion, the magnetic piece moves relatively to the magnetic part of the first stator and the magnetic parts of the second stator, and the magnetic sensor portion detects the rotating angle amount of the hand-operating portion in accordance with the movement.

With the abovementioned structure, the first stator, the magnetic sensor portion and the second stator can be disposed outside in the diameter direction of the rotor.

With this structure, since the changes of the magnetic flux are detected at the circumference of the rotor, the rotor can be downsized and disposed in a limited room, and the sensor can be downsized and then the apparatus can be downsized.

With the abovementioned structure, the detecting means can be a contact type position sensor to output signals in accordance with the rotating angle of the rotor, wherein the position sensor comprises a rotor which has a contactor and formed to rotate in synchronization with the rotation of the hand-operating portion, and a portion being contacted to which the contactor can contact while moving.

With this structure, when the rotor rotates in accordance with the rotation of the hand-operating portion, the contactor (a brush, for example) moves on the portion being contacted (a resistor pattern, for example), and the electronic signals are outputted in accordance with the movement.

With the abovementioned structure, the lever or the accelerator grip can have a linkage mechanism which can transmit rotating force to the rotor without contact, so that the rotor moves with the rotating movement of the lever.

With this structure, the contact type position sensor is modularized, and the linkage mechanism (a linkage mechanism utilizing attracting force such as a magnet etc., for example) transmits the rotating force without having contact with the modularized rotor, and the rotor is moved with the rotating movement of the lever of the accelerator grip. Consequently, even when some wobbles exist at the bearing portion of lever of the accelerator grip, the wobbles do not affect the rotating movement and accurate detection can be performed.

With the abovementioned structure, the rotor and the armature are formed to rotate integrally with the lever or the accelerator grip.

With this structure, since some parts of the position sensor (the rotor and the armature) are formed integrally as a part of the lever and the accelerator grip, reducing the number of the parts, downsizing by compacting of functional parts etc., and simplifying the structure can be obtained.

With the abovementioned structure, the rotor can be formed to rotate integrally with the accelerator grip, and the shaft of the handle can double as the armature.

With this structure, when the shaft of the handle is formed of material through which magnetic flux can pass, such as iron etc., the shaft of the handle can double as the armature which is a part of the position sensor, so that the number of the parts is reduced proportionately, and further downsizing and structure simplification are performed. Furthermore, since the gap between the armature and the first and the second stators is maintained to be constant, further accurate detection can be performed.

With the abovementioned structure, the rotor can be formed to rotate integrally with the accelerator grip, and the armature can be fixed to the shaft of the handle.

With this structure, when the shaft of the handle is formed of non-ferrous material etc., by fixing the armature to the shaft of the handle, the gap between the armature and the first and second stators can be maintained to be constant and further accurate detection can be performed.

With the abovementioned structure, the detecting means can be disposed in a waterproofed enclosure.

With this structure, since the detecting means is disposed in the waterproofed enclosure at the handle position which is relatively high in the vehicle, an excellent waterproof characteristic can be obtained and accurate detection can be performed without receiving any affect of water etc.

With the abovementioned structure, a driving circuit of an actuator which controls the throttle valve opening in accordance with the rotating angle of the hand-operating portion detected by the detecting means can be disposed in the enclosure.

With this structure, a control box which houses the circuit board etc. separately is not needed, and the actuator which controls throttle valve opening can be driven directly.

### BRIEF DISCRIPTION OF THE DRAWINGS

FIG. 1 shows an embodiment of an accelerator apparatus of the present invention; (a) is a plain view and (b) is a side view.

FIG. 2 is a sectional view of A1-A1 in FIG. 1(a).

FIG. 3 is a sectional view in the case that a contact type position sensor is adopted.

FIG. 4 shows another embodiment; (a) is a plain view and (b) is a sectional view of A2-A2.

FIG. 5 shows an embodiment of an accelerator apparatus which adopts an accelerator grip as a hand-operating portion; (a) is a side view and (b) is a side view from the direction of a handle axis.

FIG. 6(a) is a longitudinal sectional view of FIG. 5(a), and FIG. 6(b) is a sectional view of A3-A3 in FIG. 6(a).

FIG. 7(a) is a longitudinal sectional view showing a modified example of the embodiment shown in FIG. 6, and FIG. 7(b) is a sectional view of A4-A4 in FIG. 7(a).

FIG. 8(a) is a longitudinal sectional view showing a modified example of the embodiment shown in FIG. 6, and FIG. 8(b) is a sectional view of A5-A5 in FIG. 8(a).

FIG. 9 is a sectional view further showing another embodiment.

FIG. 10 is a sectional view further showing another embodiment.

FIG. 11 is a sectional view further showing another embodiment.

FIG. 12 is a sectional view further showing another embodiment.

FIG. 13 shows an embodiment which adopts a thumb lever used for snowmobiles as a hand-operating portion; (a) is a plain view and (b) is a sectional view of A6-A6 in (a).

### BEST MODE FOR CARRYING OUT THE INVENTION

The embodiments of the present invention are explained in the following with reference to the attached drawings.

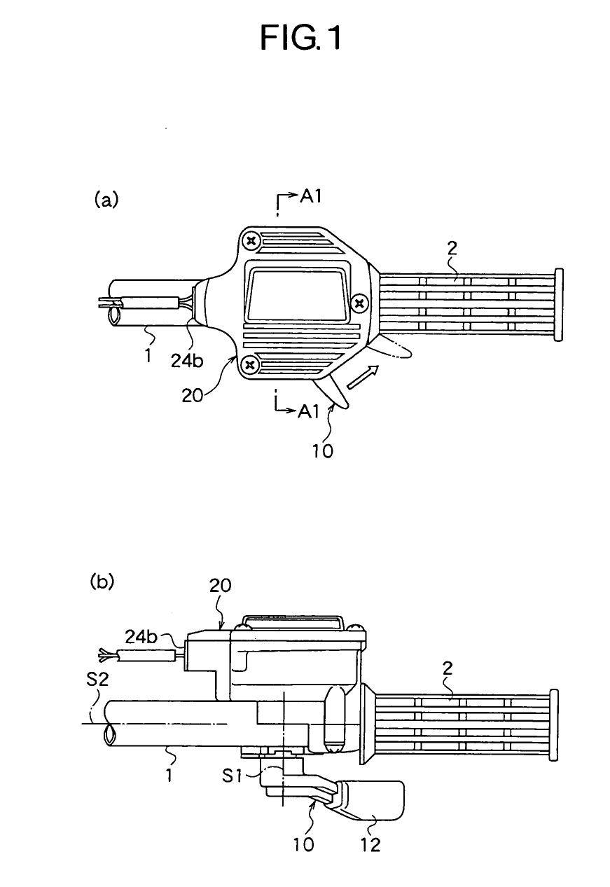

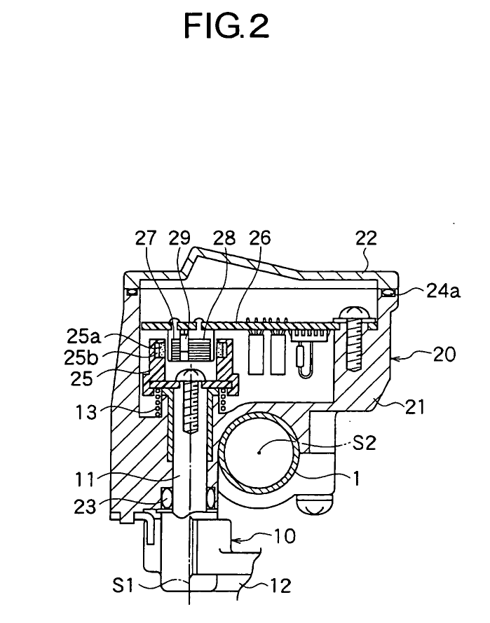

FIG. 1 and FIG. 2 show an embodiment of an accelerator apparatus of the present invention. A thumb lever is adopted as a hand-operating portion, and a part of detecting means is assembled as a part of the thumb lever so that a sensor is integrated. As shown in FIG. 1 and FIG. 2, a grip 2 is fitted and fixed to the end portion of a steering handle shaft 1. At the inner side of it, the thumb lever 10 is supported rotatably, and a non-contact type position sensor 20 is disposed thereon as the detecting means.

The thumb lever 10 is constructed of a shaft portion 11 as a specific shaft which axis S1 is located at a twisted position from the axis S2 of the handle shaft 1, and an arm portion 12 wherein one end is fixed to the lower end of the shaft portion 11 and the other end is formed as a free end where a thumb or the like presses. The thumb lever 10 is urged to return to a specific position (the initial position shown by a solid line in FIG. 1(a)) by a return spring 13 as urging means.

The non-contact type position sensor 20 has a case 21 and a cover 22 as an enclosure, and the inside of the enclosure is formed as a waterproofed construction with a seal 23 disposed at a portion supporting the shaft portion 11, a seal 24a disposed at a connecting portion of the cover 22, and a grommet 24b disposed around wires.

Inside the waterproofed space, a cylindrical rotor 25 is fixed at the upper end of the shaft portion 11, and a circuit board 26, on which a driving circuit of an actuator that controls throttle valve opening in accordance with output signals of the sensor is disposed, is fixed above the rotor 25. A first stator 27, a second stator 28 and a Hall IC 29 as a magnetic sensor portion, which are disposed on the circuit board 26, are formed integrally and inserted to an inner space of the rotor 25 at a non-contact state.

Therefore, a control box for separately housing the circuit board etc. is not needed, the actuator which controls the throttle valve opening can be driven directly, and the waterproof characteristic is improved because waterproofed space covers entirely.

In the rotor 25, an arc-shaped magnet piece 25a is embedded at the inner side, and an arc-shaped armature 25b which forms a magnetic path is embedded to contact with the outside of the magnet piece 25a. The first stator 27 has a magnetic part which faces the magnet piece 25a with a specific gap. The second stator 28 has two magnetic parts which are adjacent to the magnetic part of the first stator 27 and which face the magnet piece 25a with a specific gap. The Hall IC 29 as a magnetic sensor portion detects changes of magnetic flux passing between the first stator 27 and the second stator 28, which are caused by the movement of the magnet piece 25a, namely by the rotation of the rotor 25, and outputs electronic signals in accordance with the rotating angle of the rotor 25.

Following is an explanation about the operation of the apparatus. When a driver rotates the thumb lever 10 by a thumb or the like, the rotor 25 rotates in synchronization with the rotation (integrally with the rotation), and the Hall IC 29 outputs electronic signals in accordance with position changes of the magnet piece 25a.

In this embodiment, since the rotor 25 etc. are disposed to detect the rotating angle around the axis at which the thumb lever 10 rotates, the parts can be located closely around the thumb lever 10, and the apparatus can be downsized. Further, since the thumb lever 10 and the rotor 25 are connected directly, the play can be small and accurate detection can be performed.

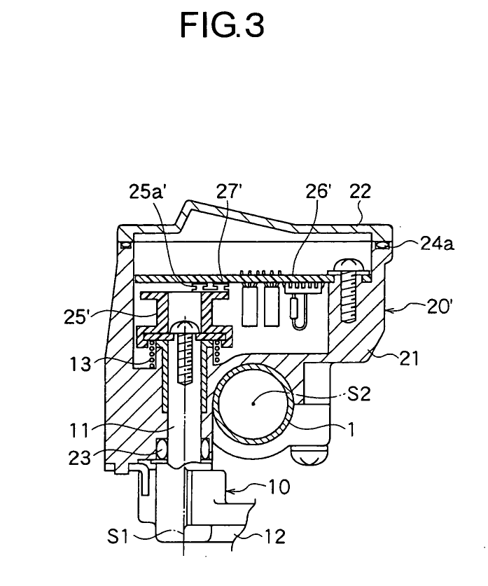

FIG. 3 shows an embodiment as is the case of FIG. 1 and FIG. 2 except for changing the position sensor as the detecting means. Here, the same numerical note is given to the same structure to omit the explanation.

The accelerator apparatus of this embodiment comprises a contact type position sensor 20′ as the detecting means. As shown in FIG. 3, a rotor 25′ is fixed at the upper end of the shaft potion 11 to rotate integrally, and a brush 25a′ as a contactor is disposed on the upper face of the rotor 25′. Further, a resistor pattern 27′ as a portion being contacted is printed on a circuit board 26′, and the brush 25a′ can move on the resistor pattern 27′ while having contact.

Therefore, when a driver rotates the thumb lever 10 by a thumb or the like, the rotor 25′ rotates in synchronization with the rotation (integrally with the rotation), electronic signals are outputted in accordance with the position changes of the brush 25a′.

In this embodiment, as is the case mentioned above, downsizing the apparatus and improving waterproof characteristic etc. are obtained.

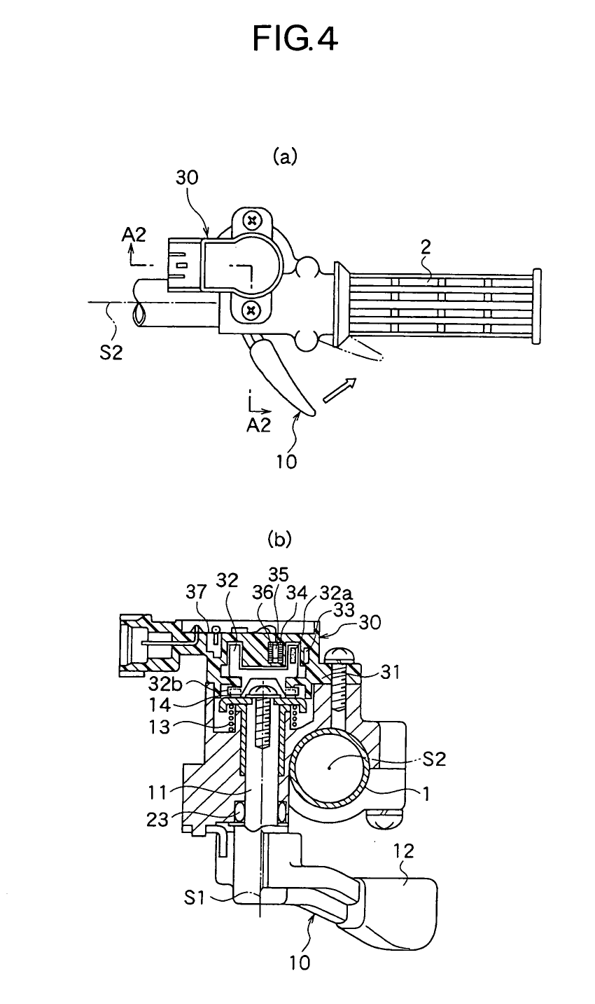

In contrast to the embodiment of FIG. 2, the non-contact type position sensor in FIG. 4 is modularized as a separate form so as to be retrofitted. Here, the same numerical note is given to the same structure of the abovementioned embodiment to omit the explanation.

In this embodiment, as shown in FIG. 4, a stopper lever 14 as an engaging portion is formed integrally at the upper end of the shaft portion 11. The non-contact type position sensor 30 has a cylindrically formed rotor 32 which is supported rotatably by a main body portion 31, and a magnet piece 32a is embedded in a part of it.

Further, an armature 33 is embedded in the main body portion 31 so as to face the magnet piece 32a from the outside in the diameter direction, and the length of the armature 33 is set to cover the moving range of the magnet piece 32a. Furthermore, a first stator 34, a Hall IC 35 and a second stator 36 are embedded in the main body portion 31 being arranged sequentially so as to face the magnetic piece 32a from the inside in the diameter direction. A portion being engaged 32b to which the stopper lever 14 engages is formed at the lower end of the rotor 32.

Following is an explanation about the operation of the apparatus. When a driver rotates the thumb lever 10 by a thumb or the like, the rotating force is transmitted to the rotor 32 via the stopper lever 14 and the portion being engaged 32b, and the rotor 32 rotates together (in synchronization) with the rotation of the thumb lever 10. As the rotor 32 rotates, the Hall IC 35 outputs electronic signals in accordance with position changes of the magnet piece 32a.

In this embodiment, since the sensor can be assembled as a module and the thumb lever 10 moves together with the rotor 32, even when some wobbles exist at the shaft portion 11 of the thumb lever 10, the wobbles do not affect the sensor side. Therefore, accurate detection can be performed.

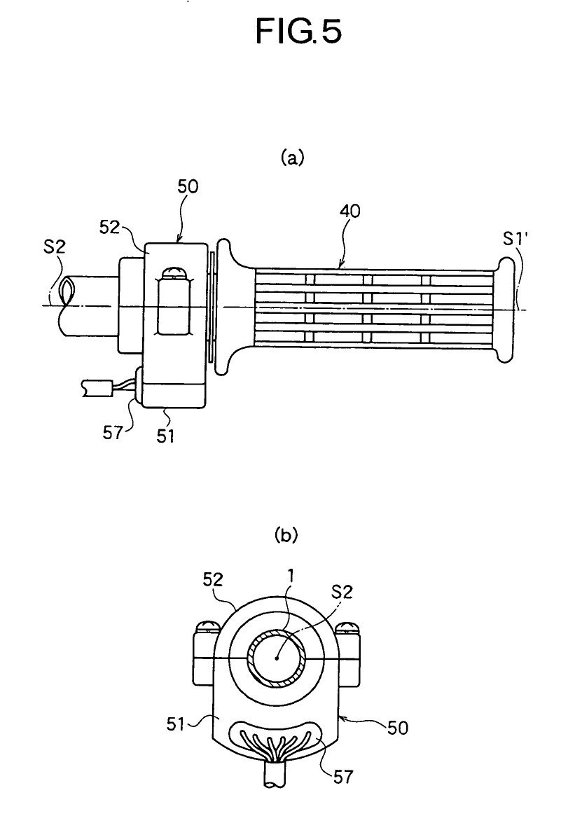

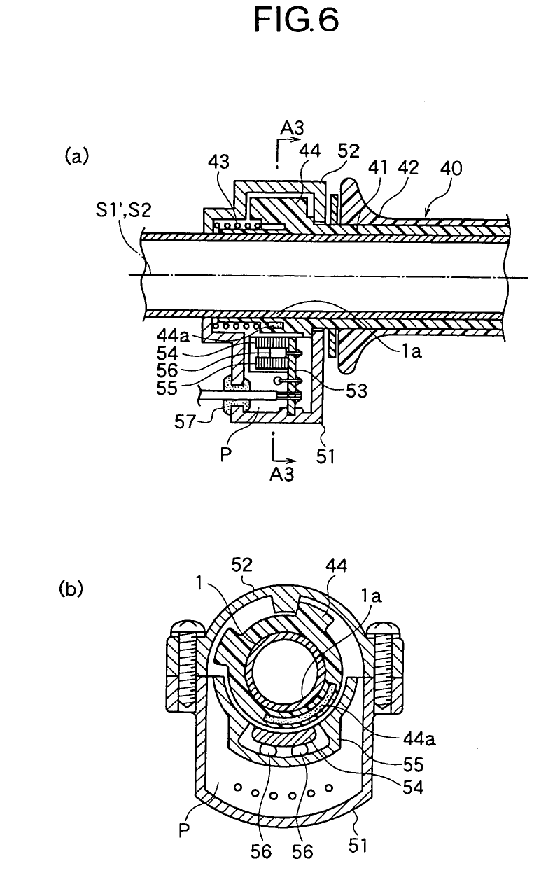

FIG. 5 and FIG. 6 show another embodiment of an accelerator apparatus of the present invention. Here, an accelerator grip is adopted as a hand-operating portion, and a part of the detecting means is assembled as a part of the accelerator grip so as to form a structure of an integrated sensor. As shown in FIG. 5 and FIG. 6, the accelerator grip 40 is fitted outside rotatably to the end portion of the handle shaft 1 for steering. At the inner side of it, a non-contact type position sensor 50 is disposed as the detecting means.

The accelerator grip 40 is disposed so that its rotating axis S1′ is almost the same as the axis S2 of the handle shaft 1, and is formed by a plastic-made grip case 41 which is fitted outside rotatably to the handle shaft 1, a rubber-made grip 42 which is fitted so as to cover the outside of the grip case 41, and so on. The accelerator grip 40 is urged to return to a specific position (the initial position where it stops to rotate counterclockwise in FIG. 6(b)) by a return spring 43 as the urging means.

The non-contact type position sensor 50 has a case 51 and a cover 22 as an enclosure. The enclosure houses an enlarged portion 44 of the grip case 41, a circuit board 53 on which a driving circuit of an actuator that controls the throttle valve opening in accordance with output signals of the sensor, a first stator 54 and a second stator 55 and a Hall IC 56 as a magnetic sensor portion which are disposed on the circuit board 53, and so on. Then, in particular, the case 51 is filled with sealing resin P inside, and a grommet 57 is disposed around the wires. In this manner, it is constructed to be waterproofed to prevent the inner space from invasion of water or the like.

Therefore, a control box for separately housing the circuit board etc. is not needed, the actuator which controls the throttle valve opening can be driven directly, and the waterproof characteristic is improved because waterproofed space covers entirely.

An arc-shaped magnet piece 44a is embedded in the enlarged portion 44. The first stator 54 which has a magnetic part facing the magnet piece 44a with a specific gap and the second stator 55 which has two magnetic parts are disposed outside in the diameter direction of the magnet piece 44a.

Consequently, the enlarged portion 44 functions as the rotor of the sensor. Further, since the handle shaft 1 is formed of ferrous material through which magnetic flux can pass, a part of the handle shaft 1 which faces the magnet piece 44a functions as the armature la that forms a magnetic path.

Following is an explanation about the operation of the apparatus. When a driver grabs and rotates the accelerator grip 40, the rotor (the enlarged portion) 44 rotates integrally with the rotation (in synchronization with the rotation), and the Hall IC 56 outputs electronic signals in accordance with position changes of the magnet piece 44a.

In this embodiment, since the rotor (enlarged portion) 44 etc. are disposed to detect the rotating angle around the axis at which the accelerator grip 40 rotates, the parts can be located closely around the accelerator grip 40, and the apparatus can be downsized. Further, since some parts of the sensor (the rotor and magnet piece 44a) are formed integrally with the accelerator grip 40 and a part of the handle shaft 1 doubles as the armature la, the number of parts can be reduced and the apparatus can be downsized and simplified. Furthermore, since the accelerator grip 40 and the rotor 44 of the sensor are connected directly, the play can be small and accurate detection can be performed. Furthermore, since the gap between the armature la which constitutes the sensor and the first and the second stators 54, 55 is maintained to be constant, even when some wobbles exist at the grip case 41, namely the rotor (the enlarged portion) 44, accurate detection can be performed without receiving any affect of the wobbles.

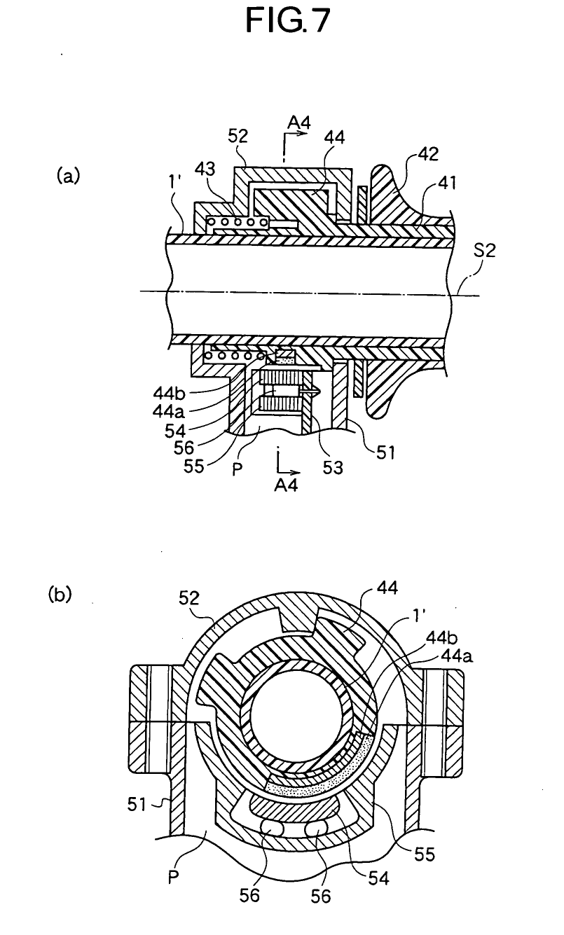

FIG. 7 shows an embodiment as is the case of FIG. 6 except for forming a separated armature. Here, the same numerical note is given to the same structure to omit the explanation. In this embodiment, since a handle shaft 1′ is formed of non-ferrous material, magnetic flux can not pass through. Then, an armature 44b is embedded with the magnet piece 44a in the enlarged portion 44 of the grip case 41.

In this embodiment, since the first stator 54, the Hall IC 56 and the second stator 55 are arranged sequentially outside the stator 44 so as to detect at the circumference of the rotor 44. Consequently, downsizing, compacting etc. of the apparatus can be obtained.

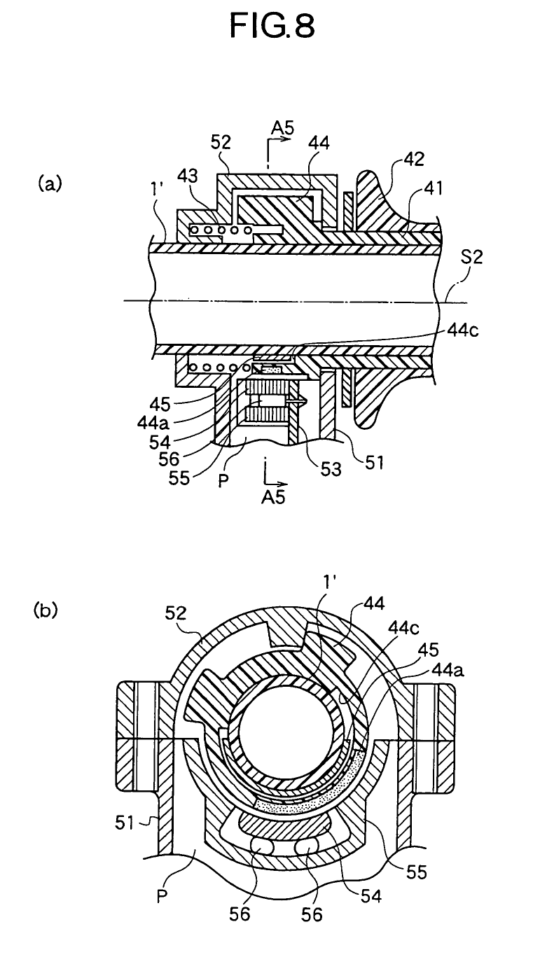

FIG. 8 shows an embodiment as is the case of FIG. 7 except for fixing an armature which forms a magnetic path to the handle shaft 1′. Here, the same numerical note is given to the same structure to omit the explanation. In this embodiment, a lightening portion 44c is formed at the enlarged portion 44 of the grip case 41. In this space, an armature 45 is fixed to the circumference face of the handle shaft 1′.

In this manner, since the gap between the armature 45 which constitutes the sensor and the first and the second stators 54, 55 is maintained to be constant, even when some wobbles exist at the grip case 41, namely the rotor (the enlarged portion) 44, accurate detection can be performed without receiving any affect of the wobbles.

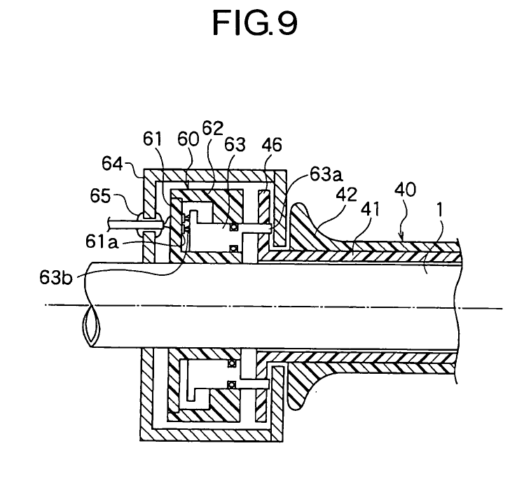

FIG. 9 through FIG. 12 further shows another embodiment. An accelerator grip is adopted as the hand-operating portion, and the detecting means is constructed as a module which is formed separately from the accelerator grip. Here, the same numerical note is given to the same structure to omit the explanation. Incidentally, although the return spring as the urging means is not shown in the figures, similar one is adopted as the embodiment mentioned above.

In the embodiment shown in FIG. 9, an engaging portion 46 is formed integrally at the inner end portion of the grip case 41. A contact type position sensor 60 is modularized so as to function by itself, and is fitted and fixed to the handle shaft 1.

The position sensor 60 is constructed of a sensor board 61 which doubles as a bearing portion, a cover 62, and a rotor 63 which is supported rotatably by the bearing portion. The rotor 63 has a projecting portion (a part) 63a which can engage with the engaging portion 46 of the grip case 41 and a brush 63b as a contactor. Besides the various circuit patterns, a resistor pattern 61a as a portion being contacted to which the brush 63a contacts is printed on the sensor board 61. Wires extended from the sensor board 61 are led outside through a grommet 65 which is attached to an enclosure 64.

Following is an explanation about the operation of the apparatus. When a driver grabs and rotates the accelerator grip 40, the rotating force is transmitted to the rotor 63 via the engaging portion 46 and the projecting portion 63a, and the rotor 63 rotates with the rotation (in synchronization with the rotation)of the accelerator grip 40. When the rotor 63 rotates, the brush 63b moves on the resistor pattern 61a, and electronic signals are outputted in accordance with the position changes.

In this embodiment, since the sensor is assembled as a separate module, even when some wobbles exist at the accelerator grip 40, accurate detection can be performed without receiving any affect of the wobbles.

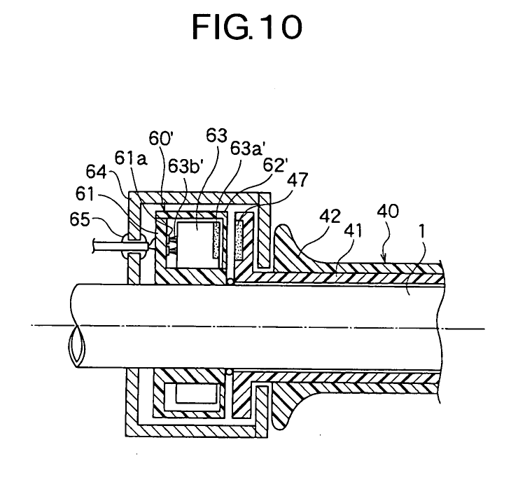

In the embodiment shown in FIG. 10, the contact type linkage between the accelerator grip 40 and the rotor 63 in the embodiment of FIG. 9 is changed to a non-contact type.

In this embodiment, a magnet 47 is embedded at the inner end portion of the grip case 41. A magnet 63a′ is embedded in a rotor 63′ of a contact type position sensor 60′at the position which faces the magnet 47 in the grip case 41. Specifically, the linkage mechanism is constructed by the magnet 47 and the magnet 63a′ to transmit the rotating movement of the accelerator grip 40 to the rotor 63′ without any contact. The rotor 63′ is covered entirely by the sensor board 61 and a cover 62′. In this manner, it is constructed to be waterproofed to prevent the inner space from invasion of water or the like.

Following is an explanation about the operation of the apparatus. When a driver grabs and rotates the accelerator grip 40, the rotating force is transmitted to the rotor 63′ by the attracting force (magnet coupling) of the magnet 47 and the magnet 63a′. When the rotor 63′ rotates, the brush 63b′ moves on the resistor pattern 61a, and electronic signals are outputted in accordance with the position changes.

In this embodiment, since the linkage mechanism adopts a non-contact type structure, the waterproof characteristic is improved compared with that of the embodiment shown in FIG. 9.

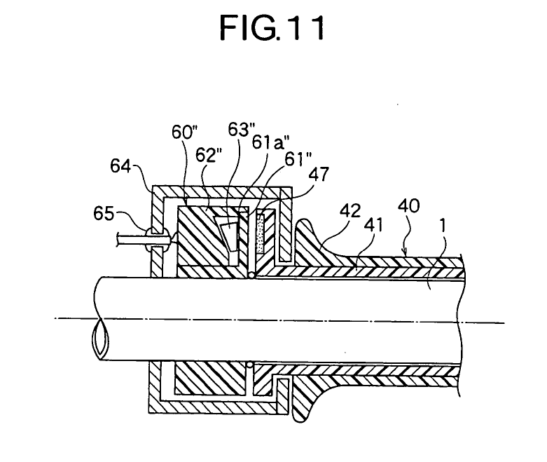

In the embodiment shown in FIG. 11, the rotor in the embodiment shown in FIG. 10 is modified. In this embodiment, a contact type position sensor 60″ is constructed of a sensor board 61″, a cover 62″, a roller 63″ which rolls in the inner space as a rotor, and so on. The roller 63″ is conical and trapezoidal in shape, electrically conductive, and attracted to the magnet 47. Specifically, the linkage mechanism is constructed by the magnet 47 and the roller 63″ to transmit the rotating movement of the accelerator grip 40 to the rotor (the roller 63″) without any contact. The rotor 63″ is entirely covered by the sensor board 61″ and a cover 62″. In this manner, it is constructed to be waterproofed to prevent the inner space from invasion of water or the like.

Following is an explanation about the operation of the apparatus. When a driver grabs and rotates the accelerator grip 40, the magnet 47 attracts and rotates the roller 63″. Then, the roller 63″ moves on a resistor pattern 61a″, and electronic signals are outputted in accordance with the position changes.

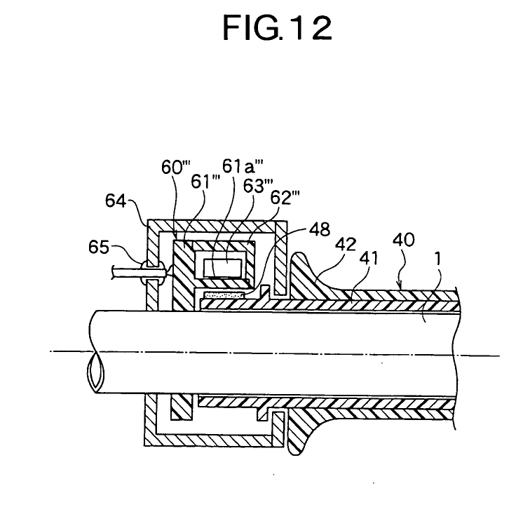

In the embodiment shown in FIG. 12, the rotor in the embodiment shown in FIG. 11 is modified. In this embodiment, a magnet 48 which is curved along the circumference of the handle shaft 1 is embedded in the region of the inner end portion of the grip case 41. A contact type position sensor 60′″ is constructed of a sensor board 61′″, a cover 62′″, a roller 63′″ which rolls in the inner space, and so on. The roller 63′″ is cylindrical in shape, electrically conductive, attracted to the magnet 48, and supported so as to roll on a circle which center is the same as that of the handle shaft 1. Specifically, the linkage mechanism is constructed by the magnet 48 and the roller 63′″ to transmit the rotating movement of the accelerator grip 40 to the rotor (the roller 63′″) without any contact. The rotor 63′″ is entirely covered by the sensor board 61′″ and a cover 62′″. In this manner, it is constructed to be waterproofed to prevent the inner space from invasion of water or the like.

Following is an explanation about the operation of the apparatus. When a driver grabs and rotates the accelerator grip 40, the magnet 48 attracts and rotates the roller 63′″. Then, the roller 63′″ moves on a resistor pattern 61a′″, and electronic signals are outputted in accordance with the position changes.

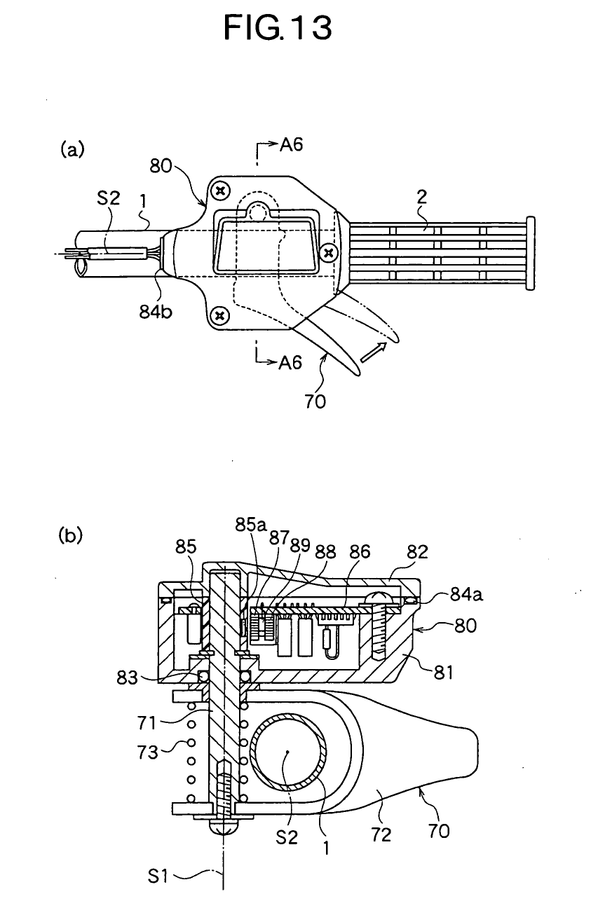

FIG. 13 further shows another embodiment. In this embodiment, a thumb lever which is employed for snowmobiles is adopted as a hand-operating portion. Here, a part of the detecting means is assembled to be operated integrally with the thumb lever and constructed so that a sensor is integrated. As shown in FIG. 13, a grip 2 is fitted and fixed to the end portion of a handle shaft 1 for steering. At the inner side of it, the thumb lever 70 is supported rotatably, and a non-contact type position sensor 80 is disposed thereon as the detecting means.

The thumb lever 70 is constructed of a shaft portion 71 as a specific shaft which axis Si is located at a twisted position from the axis S2 of the handle shaft 1, and an arm portion 72 wherein one end is fixed to the lower end of the shaft portion 71 and the other end is formed as a free end where a palm or the like presses. The thumb lever 70 is urged to return to a specific position (the initial position shown by a solid line in FIG. 13(a)) by a return spring 73 as the urging means.

The non-contact type position sensor 80 has a case 81 and a cover 82 as an enclosure, and the inside of the enclosure is formed as a waterproof construction with a seal 83 disposed at a portion supporting the shaft portion 71, a seal 84a disposed at a connecting portion of the cover 82, and a grommet 84b disposed around the wires.

Inside the waterproofed space, a cylindrical rotor 85 is fixed at the upper end of the shaft portion 71, and a circuit board 86 is fixed, wherein a driving circuit of an actuator that controls the throttle valve opening in accordance with output signals of the sensor is disposed on the circuit board 86. A first stator 87, a second stator 88 and a Hall IC 89 as a magnetic sensor portion, which are disposed on the circuit board 86, are formed integrally and disposed at the circumference of the rotor 85 at a non-contact state.

Therefore, a control box for separately housing the circuit board etc. is not needed, and the actuator which controls the throttle valve opening can be driven directly, and the waterproof characteristic is improved because waterproof space covers entirely.

An arc-shaped magnet piece 85a is embedded at the rotor 85. A first stator 87 has a magnetic part which faces the magnetic piece 85a with a specific gap. A second stator 88 has two magnetic parts which are adjacent to the magnetic part of the first stator 87 and which face the magnetic piece 85a with a specific gap.

Following is an explanation about the operation of the apparatus. When a driver rotates the thumb lever 70, the rotor 85 rotates integrally with the rotation (in synchronization with the rotation), and the Hall IC 89 outputs electronic signals in accordance with position changes of the magnet piece 85a.

In this embodiment, since the rotor 85 etc. are disposed to detect the rotating angle around the axis at which the thumb lever 70 rotates, the parts can be located closely around the thumb lever 70, and the apparatus can be downsized. Further, since the thumb lever 70 and the rotor 85 are connected directly, the play can be small and accurate detection can be performed.

With the embodiments mentioned above, when it is needed to construct the rotating center of the rotor and the center of the arc of the stator to be concentric, output compensation or output characteristics can be set freely by adopting a programmable Hall IC.

Further, in the embodiments mentioned above, the rotating axis of the thumb lever 10, 70 is located at a twisted position from the axis of the handle shaft 1. However, it is also possible to be located at an intersecting position. Furthermore, in the embodiments mentioned above, at the case when the sensor is the separate type, the accelerator grip is adopted for the hand-operating portion in the non-contact type linkage mechanism. However, the thumb lever can also be adopted as is the case above. Furthermore, although only the contact type is explained as the separate type sensor, the non-contact type can also be adopted.

### INDUSTRIAL APPLICABILITY

As mentioned above, with the accelerator apparatus of the present invention, the drive-by-wire system which has a downsized, lightened and simplified structure can be adopted to vehicles such as motorcycles, leisure vehicles, snowmobiles, leisure boats or the like, and precise and exhaustive engine control can be provided without losing the operativity of the steering handle.

1. An accelerator apparatus which is attached to a steering handle of a vehicle, and which outputs an electronic signal of the accelerator position while said position is controlled by hand-operation, comprising:
a hand-operating portion which is supported rotatably around an axis of a specific shaft;
urging means which urges said hand-operating portion to return to a specific position; and
detecting means which detects a rotating angle of said hand-operating portion around the axis of said specific shaft.

2. The accelerator apparatus according to claim 1, wherein the axis of said specific shaft locates at a intersecting or twisted position to the axis of said handle, and said hand-operating portion is a lever which one end is formed to rotate integrally with said specific shaft and the other end is a free end.

3. The accelerator apparatus according to claim 1, wherein the axis of said specific shaft locates at almost a same position as the axis of said handle, and said hand-operating portion is an accelerator grip which is fitted outside and supported rotatably to the shaft of said handle.

4. The accelerator apparatus according to claim 2 and claim 3, wherein said detecting means is a non-contact position sensor to output a signal in accordance with a rotating angle of a rotor, wherein said position sensor comprises:
said rotor which has a magnet piece formed as a curved arc shape, and formed to rotate in synchronization with the rotation of said hand-operating portion;
a first stator which has a magnetic part formed to face said magnet piece with a specific gap;
a second stator which has two magnetic parts formed to face said magnet piece and said magnetic part with a specific gap;
an armature which forms a magnetic path; and
a magnetic sensor portion which is disposed between said first stator and said second stator and outputs an electronic signal in accordance with a change of magnetic flux.

5. The accelerator apparatus according to claim 4, wherein said first stator, said magnetic sensor portion and said second stator are disposed at the outside in the diameter direction of said rotor.

6. The accelerator apparatus according to claim 2 and claim 3, wherein said detecting means is a contact type position sensor to output a signal in accordance with a rotating angle of a rotor, wherein said position sensor comprises:
a rotor which has a contactor and formed to rotate in synchronization with the rotation of said hand-operating portion; and
a portion being contacted to which said contactor can contact while moving.

7. The accelerator apparatus according to claim 6, wherein said lever has a linkage mechanism which can transmit rotating force to said rotor without contact, so that said rotor moves with the rotating movement of said lever.

8. The accelerator apparatus according to claim 6, wherein said accelerator grip has a linkage mechanism which can transmit rotating force to said rotor without contact, so that said rotor moves with the rotating movement of said accelerator grip.

9. The accelerator apparatus according to claim 4, wherein said rotor and said armature are formed to rotate integrally with said lever.

10. The accelerator apparatus according to claim 4, wherein said rotor and said armature are formed to rotate integrally with said accelerator grip.

11. The accelerator apparatus according to claim 5, wherein said rotor is formed to rotate integrally with said accelerator grip, and the shaft of said handle doubles as said armature.

12. The accelerator apparatus according to claim 5, wherein said rotor is formed to rotate integrally with said accelerator grip, and said armature is fixed to the shaft of said handle.

13. The accelerator apparatus according to claim 1, wherein said detecting means is disposed in a waterproofed enclosure.

14. The accelerator apparatus according to claim 13, wherein a driving circuit of an actuator which controls throttle valve opening in accordance with the rotating angle of said hand-operating portion detected by said detecting means is disposed in said enclosure.
